(19) United States
(12) Patent Application Publication
(10) Pub. No.: US 2020/0118732 A1
(43) Pub. Date: Apr. 16, 2020

(54) COIL UNIT

(71) Applicant: Toyota Jidosha Kabushiki Kaisha, Toyota-shi Aichi-ken (JP)

(72) Inventor: Hiroaki Yuasa, Miyoshi-shi (JP)

(21) Appl. No.: 16/597,960

(22) Filed: Oct. 10, 2019

(30) Foreign Application Priority Data
Oct. 12, 2018 (JP) 2018-193401

(51) Int. Cl. H01F 27/28; H01F 27/24; H01F 1/34; H01F 38/14

(52) U.S. Cl. CPC H01F 27/2823; H01F 27/24; B60L 53/12; H01F 38/14; H01F 1/344

(57) ABSTRACT

A power transmission device includes: a ferrite formed as a plate having a prescribed shape with a plurality of corners as viewed in a thickness direction; and a power transmission coil arranged in a spiral pattern along one of main surfaces of the ferrite in the thickness direction, such that a coil wire surrounds a winding axis passing through the main surface. The power transmission coil is formed such that an outer periphery of the power transmission coil is located on an inner side relative to each corner at the corner, and a first coil width A between an inner periphery and the outer periphery of the power transmission coil at the corner is longer than a second coil width B between the inner periphery and the outer periphery of the power transmission coil at a position different from the corner.

### CROSS REFERENCE TO RELATED APPLICATIONS

This nonprovisional application claims priority to Japanese Patent Application No. 2018-193401 filed on Oct. 12, 2018 with the Japan Patent Office, the entire contents of which are hereby incorporated by reference.

### BACKGROUND

### Field

The present disclosure relates to a coil unit for use in wireless power transmission.

### Description of the Background Art

A wireless power transmissiorr system for wirelessly transmitting power between two coil units is conventionally known. Examples of the coil units for use in wireless power transmission include a coil unit having a laminated structure of a coil and a ferrite. The coil is formed into a substantially polygonal shape, for example, by winding a coil wire constituting a winding a plurality of times to surround a winding axis.

The coil units thus configured enable power transmission when they are positioned to face each other. When using the coil unit as a power transmission coil, for example, a supply of AC power to the coil unit causes an AC current to flow through the coil unit. Here, a magnetic flux is formed around the coil unit. That is, the magnetic flux is emitted radially from a central portion of the coil unit. The magnetic flux emitted from the central portion of the coil unit enters an outer peripheral end of the ferrite. The magnetic flux that has entered the ferrite flows through the ferrite and returns to the central portion of the coil unit. In this manner, the magnetic flux formed around the power transmission coil passes through a power reception coil, causing a power reception current to flow through the power reception coil, and the power reception coil receives power.

With regard to such a coil unit, for example, Japanese Patent Laying-Open No. 2016-103589 discloses a quadrangular coil shape, in which a coil width indicated by the length from a coil wire on the inner peripheral side to the coil wire on the outer peripheral side is a constant width around the entire periphery. This publication also discloses a quadrangular ferrite shape, for example.

### SUMMARY

However, if the coil unit thus configured (for example, a power transmission coil) and the facing coil unit (for example, a power reception coil) are positionally misaligned simultaneously in two of a plurality of directions along side portions of the substantially polygonal shape, for example, from their prescribed relative positions during power transmission (for example, positions where a winding axis of the power transmission coil and a winding axis of the power reception coil coincide with each other), then a coupling coefficient between the power transmission coil and the power reception coil may decrease more than when positional misalignment occurs in one direction.

An object of the present disclosure is to provide a coil unit in which a decrease in coupling coefficient is suppressed if the coil unit is positionally misaligned relative to a facing coil unit.

A coil unit according to one aspect of the present disclosure includes: a ferrite formed as a plate having a prescribed shape with a plurality of corners as viewed in a thickness direction; and a coil arranged in a spiral pattern along one of main surfaces of the ferrite in the thickness direction, such that a coil wire surrounds a winding axis passing through the main surface. The coil is formed such that an outer periphery of the coil is located on an inner side relative to each corner at the corner, and a first coil width between an inner periphery and the outer periphery of the coil at the corner is longer than a second coil width between the inner periphery and the outer periphery of the coil at a position different from the corner.

As such, the coil is formed such that the first coil width at each of the plurality of corners is longer than the second coil width at a position different from the corner. As a result, if the two coil units are positionally misaligned from their prescribed relative positions during power transmission, resulting in only one of the corners of the ferrite of one of the coil units being positioned to face the other coil unit, for example, the amount of magnetic flux at the corner can be increased. Thus, a decrease in coupling coefficient can be suppressed.

The coil may be formed such that a distance between adjacent portions of the coil wire at the corner is longer than a distance between adjacent portions of the coil wire at a position different from the corner.

As such, the first coil width can be made longer than the second coil width.

The coil may be formed such that adjacent portions of the coil wire at the corner are arranged without overlapping each other in the thickness direction, and adjacent portions of the coil wire at a position different from the corner are arranged to overlap each other in the thickness direction.

As such, the first coil width can be made longer than the second coil width.

The ferrite may have a notch formed between adjacent ones of the plurality of corners.

As such, less ferrite can be used to reduce manufacturing costs.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic diagram showing a wireless charging system 1.

FIG. 2 is a circuit diagram schematically showing wireless charging system 1.

FIG. 3 is a perspective view showing a power transmission device 3.

FIG. 4 is an exploded perspective view showing power transmission device 3.

FIG. 5 is a plan view showing an example configuration of a power transmission coil 12 and a ferrite 22 as viewed from an observation position 29 shown in FIG. 4.

FIG. 6 is a plan view showing an example configuration of power transmission coil 12 and ferrite 22 illustrated in a simplified manner.

FIG. 7 is a sectional view illustrating a magnetic path MP1 formed between power transmission device 3 and a power reception device 4.

FIG. 8 shows example relative positions of power transmission coil 12 and a power reception coil 8 in a positionally misaligned state.

FIG. 9 is a plan view showing an example configuration of power transmission coil 12 and ferrite 22 in an embodiment.

FIG. 10 shows a configuration of power transmission coil 12 near a corner 46 of ferrite 22.

FIG. 11 is a plan view showing an example configuration of power transmission coil 12 and ferrite 22 in a comparative example where a coil width is set to a constant coil width B around the entire periphery.

FIG. 12 illustrates a variation in coupling coefficient due to positional misalignment between power transmission coil 12 and power reception coil 8 in the comparative example and the embodiment.

FIG. 13 is a plan view showing an example configuration of power transmission coil 12 and ferrite 22 in a modification.

FIG. 14 shows a configuration of power transmission coil 12 near corner 46 of ferrite 22 in a modification.

### DETAILED DESCRIPTION

An embodiment of the present disclosure is described below in detail with reference to the drawings. It should be noted that the same or corresponding parts are denoted by the same characters in the drawings and description thereof will not be repeated.

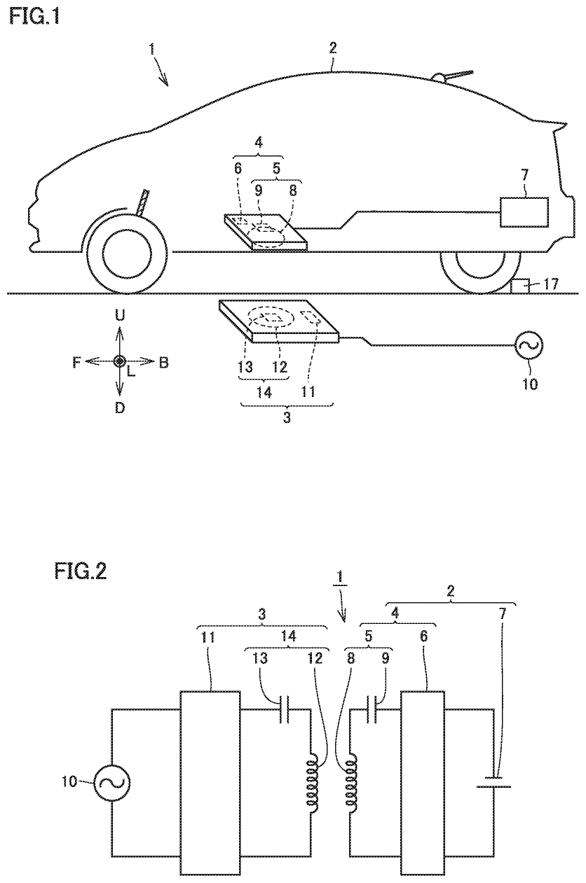

FIG. 1 is a schematic diagram showing a wireless charging system 1. FIG. 2 is a circuit diagram schematically showing wireless charging system 1. Wireless charging system 1 includes two coil units. In the following description, one of the two coil units that is connected to a power supply 10 is referred to as a power transmission device 3, and the other coil unit provided in a vehicle 2 is referred to as a power reception device 4. Vehicle 2 further includes a battery 7 in addition to power reception device 4.

Power reception device 4 includes a resonator 5, and a rectifier 6 that converts AC power received by resonator 5 into DC power and supplies it to battery 7.

Resonator 5 is an LC resonator, and includes a power reception coil 8 and a capacitor 9 connected to rectifier 6. A Q factor representing resonance intensity of resonator 5 may not be smaller than 100.

Power transmission device 3 includes a resonator 14, and a converter 1 connected to power supply 10. Converter 11 adjusts the frequency and voltage of AC power supplied from power supply 10, and supplies it to resonator 14. Resonator 14 is an LC resonator, and includes a power transmission coil 12 and a capacitor 13 connected to resonator 14. A Q factor of resonator 14 may also not be smaller than 100. Resonator 14 and resonator 5 have substantially the same resonance frequencies.

It should be noted that “U” represents an upward direction U, “D” represents a downward direction D, “F” represents a forward direction F, “B” represents a backward direction B, and “L” represents a leftward direction L in FIG. 1. It should be noted that “R” shown in FIG. 4 and the following drawings represents a rightward direction R.

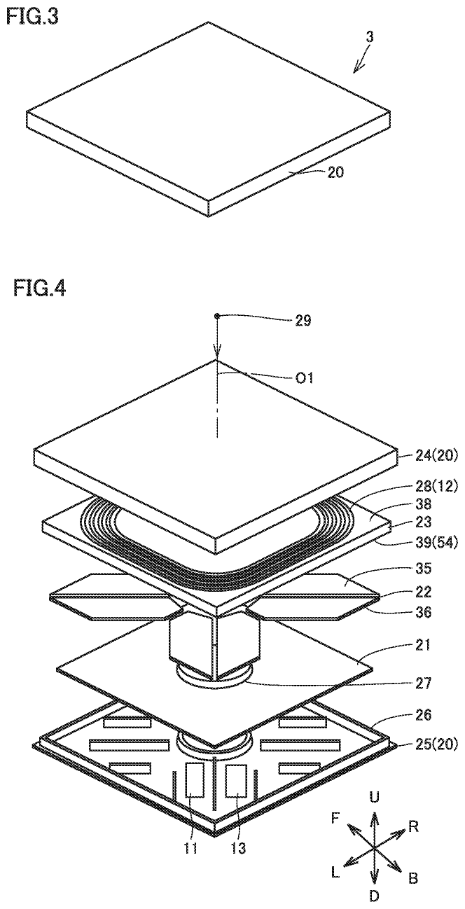

Next, an example configuration of power transmission device 3 is described using FIGS. 3 and 4. It should be noted that power reception device 4 is basically similar in circuit configuration to power transmission device 3. Thus, the configuration of power reception device 4 will not be described in detail.

FIG. 3 is a perspective view showing power transmission device 3. FIG. 4 is an exploded perspective view showing power transmission device 3. As shown in FIGS. 3 and 4, power transmission device 3 includes a housing 20, a support plate 21, a ferrite 22, and a bobbin 23. Housing 20 includes a metal base plate 25, and a resin cover 24 arranged to cover an upper surface of base plate 25. Housing 20 contains converter 11, power transmission coil 12, capacitor 13, support plate 21, ferrite 22, and bobbin 23.

Specifically, base plate 25 has a plurality of support walls 26 formed on its upper surface, with metal support plate 21 arranged on support walls 26.

Support walls 26 form a space between support plate 21 and base plate 25, with converter 11 and capacitor 13 arranged between support plate 21 and base plate 25.

Support plate 21 is a metal plate made of a metallic material (for example, aluminum) and formed as a plate. Support plate 21 has an upwardly protruding convex portion 27 formed at its central portion.

Ferrite 22 is arranged on an upper surface of support plate 21 so as to surround the periphery of convex portion 27. Ferrite 22 is a magnetic material formed as a plate. Ferrite 22 includes an upper surface (first main surface) 35 and a lower surface (second main surface) 36 that are aligned in a thickness direction of ferrite 22. Power transmission coil 12 is arranged in a spiral pattern on upper surface 35, such that a coil wire is along upper surface 35. Power transmission coil 12 is fixed in position within housing 20 by bobbin 23.

Bobbin 23 is made of an insulating material such as resin, and is formed as a plate. Bobbin 23 has a helically extending coil groove 28 formed in its upper surface 38, with power transmission coil 12 fitted in this coil groove 28.

Resin cover 24 is made of a resin material that allows a magnetic flux formed around power transmission coil 12 to pass therethrough.

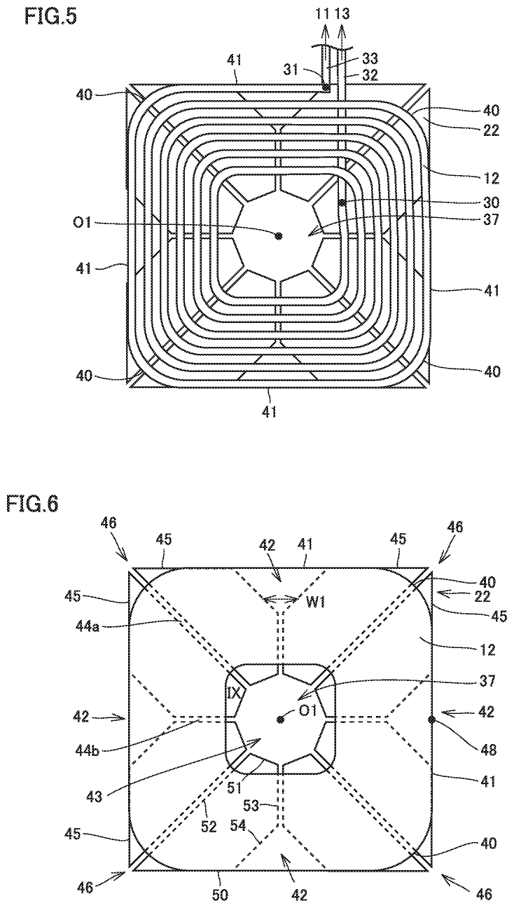

FIG. 5 is a plan view showing an example configuration of power transmission coil 12 and ferrite 22 as viewed from an observation position 29 shown in FIG. 4. As shown in FIG. 5, power transmission coil 12 is formed to surround winding axis O1. It should be noted that, in this example shown in FIG. 5, winding axis O1 extends in the thickness direction of ferrite 22 formed as a plate.

While the present embodiment describes winding axis O1 as being located in the center of an outer peripheral edge of power transmission coil 12 as an example, power transmission coil 12 is only required to be formed to surround an axis passing through a hollow portion 37, and it is not required for winding axis O1 and the center of the outer peripheral edge of power transmission coil 12 to coincide with each other.

Power transmission coil 12 includes a coil wire end 30 on the inner peripheral side and a coil wire end 31 on the outer peripheral side. Coil wire end 30 on the inner peripheral side is connected to a drawn wire 32 connected to capacitor 13. Coil wire end 31 on the outer peripheral side is connected to a drawn wire 33 connected to converter 11.

Power transmission coil 12 is formed such that its distance from winding axis O1 increases with an increase in the number of turns of the coil from coil wire end 30 on the inner peripheral side toward coil wire end 31 on the outer peripheral side.

The outer peripheral edge of power transmission coil 12 includes a plurality of bends 40, and side portions 41 each of which connects adjacent bends 40.

In this manner, power transmission coil 12 is a polygonal spiral coil having curved corners, with hollow portion 37 formed in a central portion of power transmission coil 12.

FIG. 6 is a plan view showing an example configuration of power transmission coil 12 and ferrite 22 illustrated in a simplified manner. As shown in FIG. 6, ferrite 22 has an outer peripheral edge in a substantially polygonal shape. Ferrite 22 includes a plurality of corners 46. FIG. 6 shows an example where ferrite 22 has four corners 46. Corners 46 protrude more outward than bends 40 of power transmission coil 12.

Ferrite 22 has a plurality of notches 42 formed in its outer peripheral edge. Each notch 42 is located between corners 46 of ferrite 22. Notch 42 is formed to overlap power transmission coil 12 when power transmission coil 12 and ferrite 22 are viewed from observation position 29 (that is, in the thickness direction of ferrite 22). Notch 42 is formed at a position overlapping a central portion between adjacent bends 40, and in this example shown in FIG. 6, notch 42 is formed to overlap a central portion 48 of side portion 41. Since ferrite 22 is provided with the plurality of notches 42 in this manner, less ferrite material is required than ferrite 22 not provided with notches 42. As a result, the cost of manufacturing ferrite 22 can be reduced.

A width W1 of notch 42 in ferrite 22 in a circumferential direction of power transmission coil 12 is increased with an increase in distance from hollow portion 37 of power transmission coil 12.

Ferrite 22 has a hole 43 formed in its central portion, with voids 44a and 44b extending radially from hole 43. Hole 43 is located within hollow portion 37.

Voids 44a and 44b extend radially around winding axis O1. Void 44a reaches corner 46. Void 44b is connected to notch 42.

Ferrite 22 includes a plurality of divided ferrites 45 spaced from one another in the circumferential direction of power transmission coil 12. Each divided ferrite 45 is formed in an elongated manner to reach into hollow portion 37 of power transmission coil 12 from the outer peripheral edge of power transmission coil 12.

Divided ferrites 45 adjacent to one another in the circumferential direction of power transmission coil 12 are spaced from one another, to thereby form voids 44a and voids 44b.

An outer peripheral edge of divided ferrite 45 includes an outer peripheral side 50, an inner peripheral side 51, an oblique side 52, a short side 53, and a notch side 54. Two divided ferrites adjacent to each other are arranged symmetrically with respect to a center line (not shown) passing between short sides 53 facing each other.

Outer peripheral side 50 is located at the outer peripheral edge of ferrite 22. Inner peripheral side 51 forms part of an inner peripheral edge of hole 43. Oblique side 52 connects one end of outer peripheral side 50 and one end of inner peripheral side 51 to each other. Notch side 54 forms part of an inner peripheral edge of notch 42. Notch side 54 has one end connected to the other end of outer peripheral side 50. Short side 53 connects the other end of notch side 54 and the other end of inner peripheral side 51 to each other.

Void 44a is formed by oblique sides 52 of adjacent divided ferrites 45. Oblique side 52 is formed to be parallel to an imaginary line (not shown) from winding axis O1 to corer 46. Void 44b is formed by short sides 53 of adjacent divided ferrites 45. Short side 53 is formed to be parallel to an imaginary line (not shown) from winding axis O1 to central portion 48 of side portion 41.

Corner 46 is formed by outer peripheral sides 50 of divided ferrites 45 adjacent to each other with void 44a between them. Notch 42 is formed by notch sides 54 of divided ferrites 45 adjacent to each other with void 44b between them.

Hole 43 is formed by inner peripheral sides 51 of divided ferrites 45 aligned in the circumferential direction of power transmission coil 12.

Outer peripheral side 50 extends linearly at the tip portion side of corner 46 as well, whereas bend 40 of power transmission coil 12 is curved. Thus, corner 46 is formed to protrude more outward than power transmission coil 12.

When transmitting power wirelessly from power transmission device 3 configured as described above to power reception device 4, power reception coil 8 is arranged above power transmission coil 12 so that the two coil units are positioned to face each other. Once power transmission coil 12 and power reception coil 8 are placed in correct positional alignment at prescribed relative positions, winding axis O1 of power transmission device 3 and winding axis O1 of power reception device 4 coincide with each other.

Then, in FIG. 1, converter 11 supplies AC power of a prescribed frequency to resonator 14, causing an AC current to flow through power transmission coil 12. The AC current flowing through power transmission coil 12 has a frequency the same as the resonance frequency of resonator 14, for example.

The flow of the AC current through power transmission coil 12 leads to the formation of a magnetic flux around power transmission coil 12. When the AC current supplied to power transmission coil 12 has a frequency the same as the resonance frequency of resonator 14, a magnetic field formed around power transmission coil 12 also has a frequency the same as the resonance frequency of resonator 14.

The magnetic flux formed around power transmission coil 12 is emitted radially from winding axis O1 and its vicinity.

Then, the magnetic flux from power transmission coil 12 passes through power reception coil 8, generating an induced electromotive voltage in power reception coil 8. As a result, an AC current flows through power reception coil 8 as well, causing a supply of AC power from power transmission coil 12 to power reception coil 8.

In the following, a magnetic path MP1 from winding axis O1 and its vicinity to the outer peripheral edge of ferrite 22, based on the magnetic flux formed around power transmission coil 12, is described.

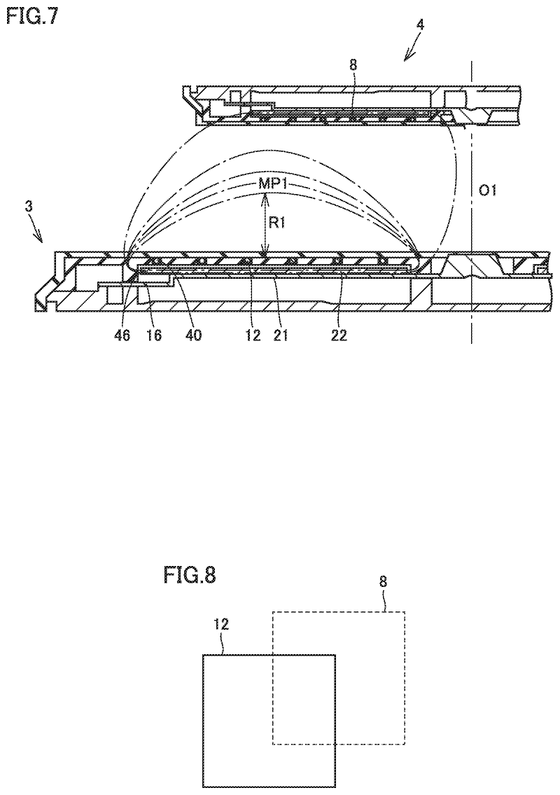

FIG. 7 is a sectional view illustrating magnetic path MP1 formed between power transmission device 3 and power reception device 4. As shown in FIG. 7, a magnetic flux formed around and in the vicinity of winding axis O1 flows from winding axis O1 and its vicinity, past above power transmission coil 12 and toward outer peripheral side 50, which is the outer peripheral edge of ferrite 22, and enters ferrite 22 from outer peripheral side 50. The magnetic flux that has entered from outer peripheral side 50 passes through ferrite 22, and returns to winding axis O1 and its vicinity again. Magnetic path MP1 is thus formed.

Magnetic path MP1 has a radius RI in FIG. 7. When following magnetic path MP1, some of the magnetic flux takes a route close to power transmission coil 12, and some of the magnetic flux takes a route away from power transmission coil 12. In FIG. 7, radius RI of magnetic path MP1 represents a maximum value of a distance between a path having an average density of the magnetic flux following magnetic path MP1, and power transmission coil 12.

Magnetic path MP1 partially passes through power reception coil 8 of power reception device 4, to thereby realize power transfer.

If power transmission coil 12 configured as described above and facing power reception coil 8 are positionally misaligned simultaneously in two of a plurality of directions along the side portions of the substantially polygonal shape, for example, from their prescribed relative positions during power transmission (for example, positions where winding axis O1 of power transmission coil 12 and winding axis O1 of power reception coil 8 coincide with each other), then a coupling coefficient between power transmission coil 12 and power reception coil 8 may decrease.

FIG. 8 shows example relative positions of power transmission coil 12 and power reception coil 8 in a positionally misaligned state. A solid line box in FIG. 8 represents power transmission coil 12, and a dashed line box in FIG. 8 represents power reception coil 8. As shown in FIG. 8, when positional misalignment occurs simultaneously in two directions (F-B direction and L-R direction) along the sides of the quadrangular shape of power transmission coil 12, the area of overlap of power reception coil 8 and power transmission coil 12 decreases as viewed from observation position 29. Accordingly, the amount of magnetic flux passing between power transmission coil 12 and power reception coil 8 decreases as compared to an example where the coils are at such relative positions that their winding axes O1 coincide with each other. As a result, the coupling coefficient decreases. In particular, when positional misalignment occurs simultaneously in two directions, power transmission coil 12 and power reception coil 8 are placed in such positions that only one of four corners 46 of power transmission coil 12 overlaps power reception coil 8, as viewed from observation position 29, which may cause the coupling coefficient to decrease more than when positional misalignment occurs in one of the plurality of directions.

In the present embodiment, therefore, a first coil width between the inner periphery and the outer periphery of power transmission coil 12 at corner 46 of ferrite 22 is set to be longer than a second coil width between the inner periphery and the outer periphery of power transmission coil 12 at a position different from corner 46.

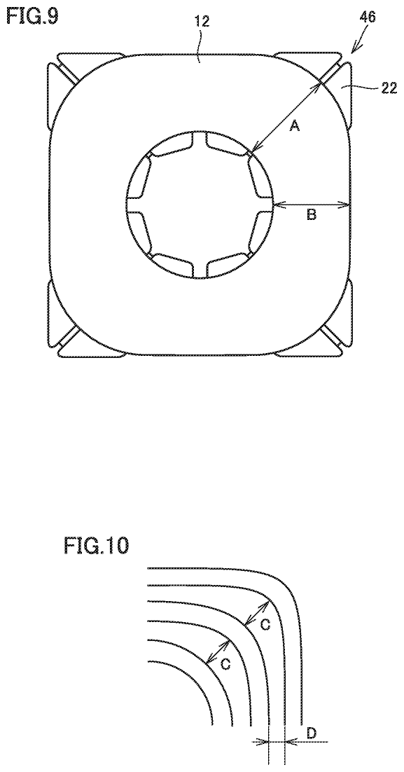

FIG. 9 is a plan view showing an example configuration of power transmission coil 12 and ferrite 22 in the present embodiment. As shown in FIG. 9, power transmission coil 12 is formed such that a first coil width A at corner 46 of ferrite 22 is longer than a second coil width B of power transmission coil 12 at a position different from corner 46 of ferrite 22.

It should be noted that first coil width A may have a length greater than half the length from winding axis O1 to the tip portion of corner 46, for example.

FIG. 10 shows a configuration of power transmission coil 12 near corner 46 of ferrite 22. As shown in FIG. 10, power transmission coil 12 is formed such that a distance C between adjacent portions of the coil wire at corner 46 of ferrite 22 is longer than a distance D between adjacent portions of the coil wire at a position different from corner 46. With such adjustment of the distances between adjacent portions of the coil wire, first coil width A can be made longer than second coil width B.

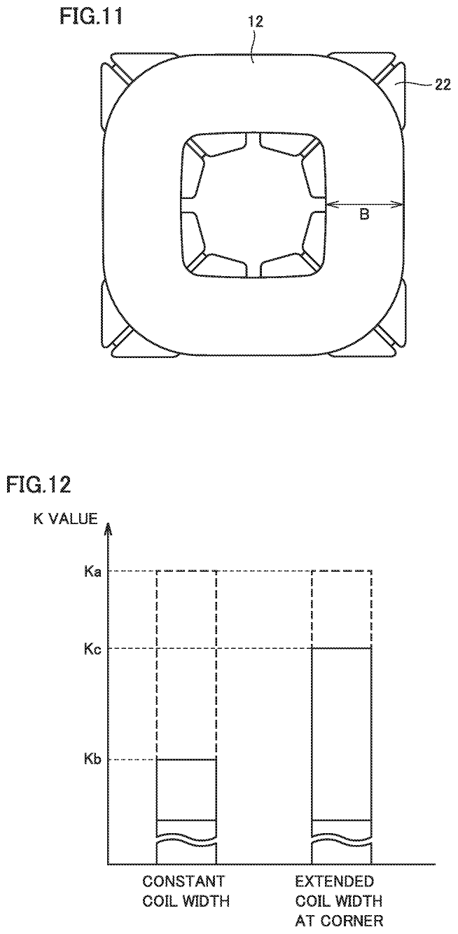

The effect obtained by power transmission coil 12 configured as described above in the present embodiment is described in comparison to a comparative example shown in FIG. 11.

It is assumed, for example, that power transmission coil 12 and power reception coil 8 are positionally misaligned simultaneously in two directions (F-B direction and L-R direction) as was illustrated in FIG. 8. When power transmission coil 12 and power reception coil 8 are in such relative positions, their corners 46 of ferrites 22 are positioned to face each other. Thus, during power transmission from power transmission coil 12 to power reception coil 8 in such relative positions, the amount of magnetic flux passing between corner 46 of ferrite 22 of power transmission coil 12 and corner 46 of ferrite 22 of power reception coil 8 has a significant impact on the coupling coefficient.

It is assumed, for example, that power transmission coil 12 has a coil width that is constant around the entire periphery except for a portion connected to a drawn wire and the like, as a comparative example.

FIG. 11 is a plan view showing an example configuration of power transmission coil 12 and ferrite 22 in the comparative example where the coil width is set to a constant coil width B around the entire periphery. In power transmission coil 12 in the comparative example, a distance between adjacent portions of the coil wire is set to a constant width around the entire periphery, for example, so that the coil width is constant around the entire periphery.

When positional misalignment occurs simultaneously in two directions as shown in FIG. 8, corners 46 of ferrites 22 are positioned to face each other as viewed from observation position 29 both in the case of power transmission coil 12 in the present embodiment shown in FIG. 9, and in the case of power transmission coil 12 in the comparative example shown in FIG. 11.

Since first coil width A is longer than second coil width B, radius RI of magnetic path MP1 formed near corner 46 of power transmission coil 12 in the present embodiment is greater than radius RI of magnetic path MP1 formed near corner 46 of power transmission coil 12 in the comparative example. Thus, magnetic path MP1 formed around power transmission coil 12 in the present embodiment is more likely to pass through power reception coil 8. Accordingly, the amount of magnetic flux passing between power transmission coil 12 and power reception coil 8 in the present embodiment is greater than the amount of magnetic flux passing between power transmission coil 12 and power reception coil 8 in the comparative example. As a result, the amount of decrease in coupling coefficient due to the positional misalignment between power transmission coil 12 and power reception coil 8 in the present embodiment is smaller than the amount of decrease in coupling coefficient due to the positional misalignment between power transmission coil 12 and power reception coil 8 in the comparative example.

FIG. 12 illustrates a variation in coupling coefficient due to the positional misalignment between power transmission coil 12 and power reception coil 8 in the comparative example and the present embodiment.

It is assumed that a coupling coefficient K has a value Ka when power transmission coil 12 and power reception coil 8 are not positionally misaligned (that is, when winding axes O1 of power transmission coil 12 and power reception coil 8 coincide with each other).

In this case, when power transmission coil 12 has constant coil width B as was shown in FIG. 11, and when power transmission coil 12 and power reception coil 8 are positionally misaligned simultaneously in two directions as was shown in FIG. 8, then the value of coupling coefficient K between power transmission coil 12 and power reception coil 8 decreases to Kb.

On the other hand, when first coil width A at corner 46 of power transmission coil 12 is set to be greater than second coil width B at a position other than corner 46 (that is, when the coil width at corner 46 is extended) as was shown in FIG. 9, and when power transmission coil 12 and power reception coil 8 are positionally misaligned simultaneously in two directions as was shown in FIG. 8, then the value of coupling coefficient K between power transmission coil 12 and power reception coil 8 decreases to Kc, which is higher than Kb. That is, by setting first coil width A to be greater than second coil width B, the decrease in coupling coefficient is suppressed as compared to the example where the coil width is set to constant coil width B.

As described above, in accordance with the coil unit according to the present embodiment, power transmission coil 12 is formed such that first coil width A at corner 46 of ferrite 22 is longer than second coil width B at a position different from corner 46. As such, if power transmission coil 12 and power reception coil 8 are positionally misaligned simultaneously in two directions from their positions where their winding axes O1 coincide with each other, the amount of magnetic flux at corner 46 can be increased. Thus, the decrease in coupling coefficient can be suppressed. Therefore, there can be provided a coil unit in which a decrease in coupling coefficient is suppressed if the coil unit is positionally misaligned relative to a facing coil unit.

Moreover, since power transmission coil 12 is formed such that the distance between adjacent portions of the coil wire at corner 46 of ferrite 22 is longer than the distance between adjacent portions of the coil wire at a position different from corner 46, the first coil width can be made longer than the second coil width.

Modifications are described below.

While power transmission coil 12 has been described as having first coil width A greater than second coil width B as an example in the embodiment above, power reception coil 8 may have first coil width A greater than second coil width B in addition to or alternatively to power transmission coil 12, for example.

Moreover, while first coil width A has been described as being greater than second coil width B by employment of a circular shape as the inner peripheral shape of power transmission coil 12 as was shown in FIG. 9 in the embodiment above, first coil width A may be greater than second coil width B by employment of a rhombic shape as the inner peripheral shape of power transmission coil 12 as shown in FIG. 13, for example. FIG. 13 is a plan view showing an example configuration of power transmission coil 12 and ferrite 22 in a modification.

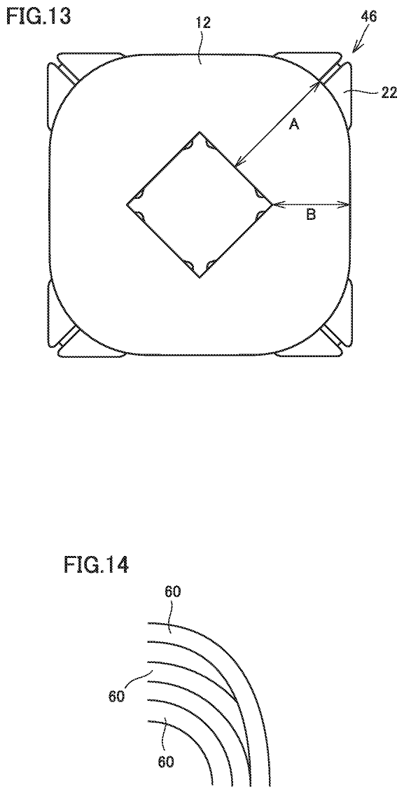

Furthermore, while first coil width A has been described as being greater than second coil width B by the configuration in which the distance between adjacent portions of the coil wire at corner 46 is longer than the distance between adjacent portions of the coil wire at a position different from corner 46 in the embodiment above, power transmission coil 12 may be formed such that adjacent portions of coil wire 60 at corner 46 are arranged without overlapping each other in the thickness direction, and adjacent portions of coil wire 60 at a position different from the corner (for example, at the side portion) are arranged to overlap each other in the thickness direction as shown in FIG. 14, for example. FIG. 14 shows a configuration of power transmission coil 12 near corner 46 of ferrite 22 in a modification. First coil width A can be made longer than second coil width B in this manner as well.

It should be noted that the modifications described above may be combined in whole or in part, as appropriate, for implementation.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A coil unit comprising:
a ferrite formed as a plate having a prescribed shape with a plurality of corners as viewed in a thickness direction; and
a coil arranged in a spiral pattern along one of main surfaces of the ferrite in the thickness direction, such that a coil wire surrounds a winding axis passing through the main surface,
the coil being formed such that an outer periphery of the coil is located on an inner side relative to each corner at the corner, and a first coil width between an inner periphery and the outer periphery of the coil at the corner is longer than a second coil width between the inner periphery and the outer periphery of the coil at a position different from the corner.

2. The coil unit according to claim 1, wherein
the coil is formed such that a distance between adjacent portions of the coil wire at the corner is longer than a distance between adjacent portions of the coil wire at a position different from the corner.

3. The coil unit according to claim 1, wherein
the coil is formed such that adjacent portions of the coil wire at the corner are arranged without overlapping each other in the thickness direction, and adjacent portions of the coil wire at a position different from the corner are arranged to overlap each other in the thickness direction.

4. The coil unit according to claim 1, wherein
the ferrite has a notch formed between adjacent ones of the plurality of corners.
